(19) United States
(12) Patent Application Publication
(10) Pub. No.: US 2013/0014209 A1
(43) Pub. Date: Jan. 10, 2013

(54) Content Management System

(75) Inventors: Franck Chastagnol, Palo Alto, CA (US); Jianliang Zhao, San Jose, CA (US); Rui Chen, San Jose, CA (US); Matthew Good, San Francisco, CA (US); Yi-Ling Su, Los Altos, CA (US); Frey Waid, San Francisco, CA (US); Zheng Liu, Palo Alto, CA (US); David King, San Francisco, CA (US)

(73) Assignee: GOOGLE INC., Mountain View, CA (US)

(21) Appl. No.: 13/619,813

(22) Filed: Sep. 14, 2012

Related U.S. Application Data
(62) Division of application No. 11/935,386, filed on Nov. 5, 2007.
(60) Provisional application No. 60/975,158, filed on Sep. 25, 2007.
(60) Provisional application No. 60/856,501, filed on Nov. 3, 2006.

(51) Int. Cl. G06F 21/00

(52) U.S. Cl. 726/1

(57) ABSTRACT

Content rights holders provide digital content to a hosting site to be used as reference content. The content owner specifies a policy for each digital content item, indicating how that content may be used on the site when uploaded by someone other than the content owner. An identification module compares the uploaded content against reference content. If the content matches reference content, the specified policy for that reference content is applied to the uploaded content. Policy options provided by the content owner include tracking the content to see how it is viewed, preventing the content from being distributed on the site, and allowing the content to be displayed in a revenue-sharing environment. In one embodiment, if the identification module matches the uploaded content to a reference item but the match does not have a sufficiently high level of confidence, the suggested match is queued for review by the content owner.

### CROSS-REFERENCE TO RELATED APPLICATIONS

This application is a division of U.S. patent application Ser. No. 11/935,386, filed on Nov. 5, 2007, which claims the benefit of U.S. Provisional Application 60/975,158, filed on Sep. 25, 2007; and of U.S. Provisional Application 60/856,501, filed on Nov. 3, 2006. Each application is incorporated by reference herein in its entirety.

### BACKGROUND

1. Field

The embodiments of the present invention generally relate to management of online content. In particular, the present invention is directed toward matching uploaded digital content to reference content and making the uploaded content available to others in accordance with policies of the content owners.

2. Description of the Related Art

The proliferation of web sites that allow users to upload multimedia content for mass viewing has brought with it a number of challenges, not the least of which has been how to detect and handle uploaded content in which other entities have rights.

Under the copyright laws of the United States and multiple other countries, a single work may have multiple copyright holders and various entities may hold other rights with regard to the content. For example, various entities have rights in a song—the author, the publisher, and the music label are just some of the many different entities that may have different rights and each may be entitled to control the use of their work, and/or to receive royalty payments under the various royalty schemes in force in a particular country. Videos have an additional layer of complexity, including, for example, synchronization rights to any music played along with the video.

While Performing Rights Organizations (PROs) such as The American Society of Composers, Authors and Publishers (ASCAP) exist to collect public performance royalties on behalf of the various copyright holders when their works are broadcast on the radio or on television, this type of collection mechanism is not available in the online environment; nor are performance rights sufficient—as noted above, mechanical, master use, synchronization and other rights must also be taken into account.

Furthermore, before appropriate actions can be taken with regard to rights holders, content must be correctly identified. Given the nature of user-generated content (UGC), that is, content provided by users to a web site, detecting content subject to the rights of others has proven to be very difficult. For example, a user may select a commercially available song, which is subject to copyright restrictions, and combine it with homemade video to which the user herself holds the copyright. UGC including, for example, copyrighted video may escape detection by being slightly different, e.g., through cropping or editing, than a reference video.

### SUMMARY

The present invention enables content rights holders to provide digital content or indicia of digital content, such as a fingerprint, to a hosting site to be used as reference content. The content owner or rights holder (hereinafter called the “content owner” for brevity) also specifies a policy for each digital content item, indicating how that content may be used on the site when a match is found between the content and content uploaded by someone other than the content owner.

The hosting site is adapted to receive user generated content (UGC) uploaded by users to an upload server. In one embodiment, the user additionally provides information about the uploaded content, such as its title, context, search keywords, and a description, and in one embodiment certifies that the user has appropriate permission to use the digital content. In one embodiment, users have accounts on the site, and are required to log in before uploading digital content.

In one embodiment, uploaded UGC is transcoded from various possible formats into one common file type once it has been uploaded. Next, an identification module compares the uploaded UGC against data in a reference database. The data in the reference database may have been provided by content owners, or may have been collected by the host site or obtained from another party, or obtained through a combination of these or other methods. If the uploaded UGC does not match content in the reference database, it is made available for download or streaming by other users of the site, subject to any other content rules imposed by the hosting site. If, however, there is a match between the uploaded UGC and content in the reference database, the specified policy for that reference content is retrieved by a policy engine to determine how the uploaded UGC should be handled. In one embodiment, the policy options provided by the content owner include tracking the content to see how it is viewed, preventing the content from being distributed on the site, and allowing the content to be displayed in a revenue-sharing environment. In one embodiment, if the identification module matches the UGC to a reference item but the match does not have a sufficiently high level of confidence, the suggested match is queued for review by the content owner.

Content owners can access the hosting site and view activity concerning their content. As noted, in one embodiment if a partial match or match with low confidence has been identified by the identification engine, the content owner can manually review the UGC and determine whether it is in fact a match. In addition the content owner can review items that have automatically been matched to reference content and had the specified policy applied. Content owners can also edit policy information for individual or groups of reference content.

In one embodiment, the host site provides a fingerprinting software program or interface to content owners, which use the program or interface to create digital fingerprints of their content and provide the fingerprints back to the host site. An identification module on the host site then compares a fingerprint of the UGC against the fingerprint supplied by the content owner to determine whether there is a match. In this embodiment, the content owner need not distribute copies of its original reference content to the host site.

In one embodiment, different policies may be associated with a single item of reference content, for example depending on the geographic location of the computer downloading that content. Similarly, different policies can be associated with a single item of content, depending on, for example, the identify of the viewer or uploader, the viewing or uploading platform, or the domain of the site from which the content is uploaded or viewed.

### BRIEF DESCRIPTION OF THE DRAWINGS

FIG. 1 is an illustration of a system for providing content rights management in accordance with an embodiment of the present invention.

FIG. 2 is a flowchart illustrating a method for providing content rights management in accordance with an embodiment of the present invention.

FIG. 3 illustrates a user interface for providing reference content to a content rights management system in accordance with an embodiment of the present invention.

FIG. 4 is a block diagram illustrating the use of revenue sharing in accordance with an embodiment of the present invention.

FIG. 5 is a screen shot of a user interface for performing a search for content by a content owner in accordance with an embodiment of the present invention.

FIG. 6 is an illustration of a system for providing a content rights management and identification service for a third party in accordance with an embodiment of the present invention.

FIGS. 7-10 illustrate examples of user interfaces that are used by content owners to review and claim content.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

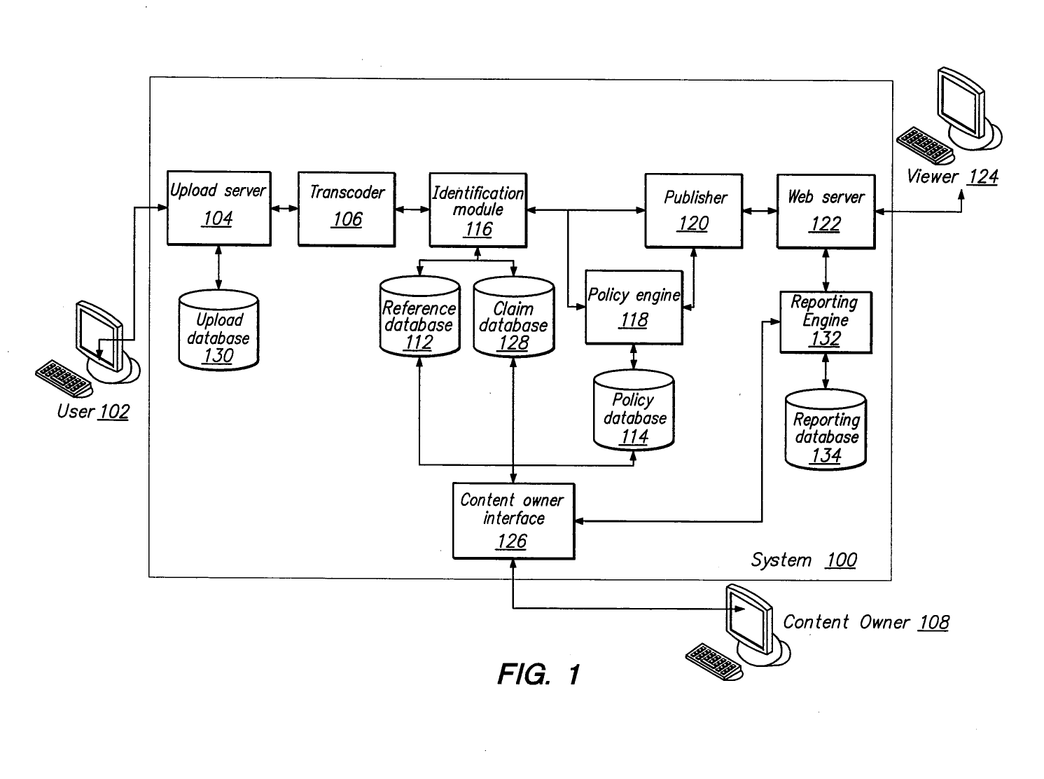

FIG. 1 illustrates a system for providing content rights management in accordance with an embodiment of the present invention. System 100 includes an upload server 104, an upload database 130, a transcoder 106, an identification module 116, a policy engine 118, a publisher 120, a web server 122, a content owner interface 126, a reference database 112, a claims database 128, a policy database 114, a reporting engine 132 and a reporting database 134. FIG. 1 also includes a user computer 102, viewer computer 124, and content owner computer 108. Each of these is described further below.

Although only a single upload server 104 and a single web server 122 are illustrated in FIG. 1 for clarity, each can be implemented as multiple servers. Other servers may handle other aspects of the host site not discussed here. It will also be understood that the described uploading and downloading or viewing of content is not intended to be limited to content uploaded or downloaded via the Internet or the HTTP protocol. Furthermore, in general, functions described in one embodiment as being performed on the server side can also be performed on the client side in other embodiments if appropriate. User computer 102, content owner 108, and viewer 124 can be combinations of a laptop, desktop, cell phone, handheld device, thin or thick client device, video appliance, or any other appropriate computing platform.

A content owner 108 is an entity that owns or controls at least some of the rights to a particular work. The content owner may be an individual, a group of individuals, or an entity such as a music or video production company or studio, artists' group, royalty collection agency, or the like.

As noted, UGC video may include audio, video, a combination of audio and video, or still images. For ease of description, the examples illustrated below assume that the UGC is video; those of skill in the art will appreciate that audio, audio combined with video, and still images can be received, identified, and acted upon in a similar way as is described here. Furthermore, we refer to a user computer that receives UGC from system 100 as a viewer 124. In various embodiments, viewer 124 may consume the UGC content via download of the file, by streaming, or by any other method of retrieving media content over a network.

Content owner interface 126 enables content owners 108 to provide content to system 100, including reference content and policy information, and further allows content owners to review and make claims to the content. Through content owner interface 126, system 100 receives reference content and policy information from content owners 108, and stores the received information in reference database 112 and policy database 114, respectively. In one embodiment, each item of reference content is assigned an identifier, and the identifier is additionally stored along with the policy information in policy database 114. Content owner interface 126 in one embodiment includes user interface and bulk processes such as ftp for exchange of content files and policy information.

In addition to performing content matching at the time of video upload, one embodiment of the present invention also enables content matching for “legacy” videos that are already uploaded to system 100. Such legacy videos may have been uploaded before the system was in place or may not have matched at the time of upload, but would match subsequently as additional reference materials are added. Such matching of legacy videos can be done, for example, periodically by rechecking all uploaded videos against the reference database. In one embodiment, such checking is done when a user requests to view or download a video.

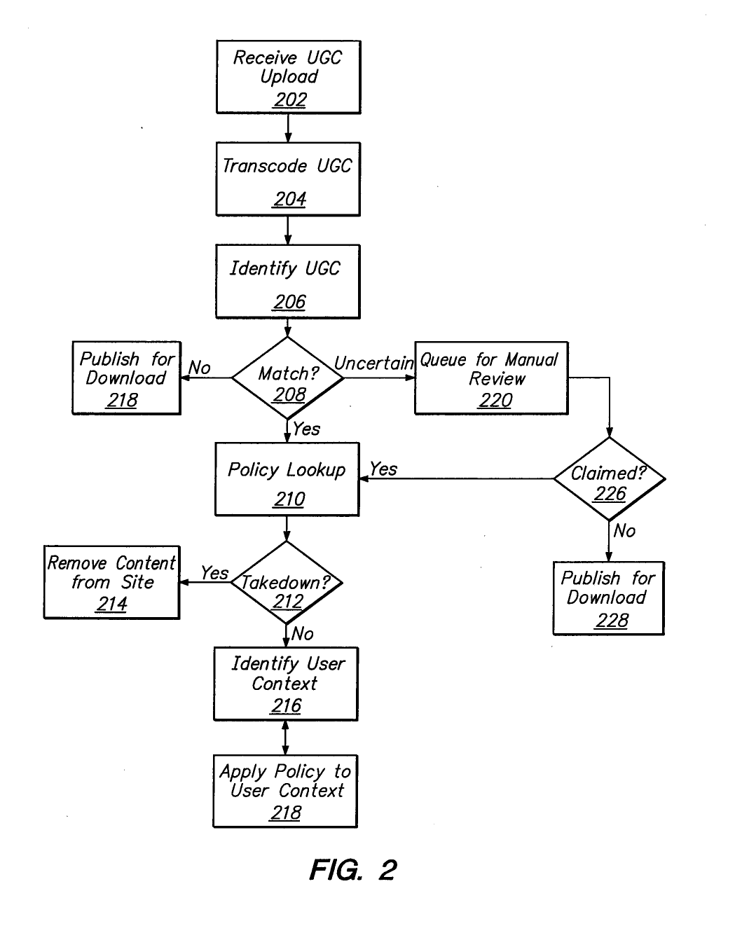

A user of system 100 uses user computer 102 to provide user generated content (UGC) to upload server 104 of system 100. In one embodiment, user computer 102 uses a Web browser such as Microsoft Internet Explorer or Mozilla Firefox to access a web server running on upload server 104. Referring to FIG. 2, upload server 104 receives 202 the UGC from user computer 102, and stores it, in one embodiment in upload database 130.

Transcoder 106 converts 204 the UGC from one file type to another, in order to standardize content for playback to viewers 124. This enables upload server 104 to accept UGC provided in various different formats, while still being able to provide a standardized output to viewers 124. In one embodiment, transcoder 106 transcodes uploaded video content into the Adobe (.flv) flash file format.

Identification module 116 analyzes 206 the uploaded and transcoded UGC to determine whether it matches reference content stored in reference database 112. If 208 a match is found, policy engine 118 looks up 210 the policy for the identified reference content and additionally logs the match in claim database 128 for subsequent review by content owner 108. In one embodiment a fingerprinting methodology is used to compare the UGC to the reference content. Additional techniques such as watermarking, MD5 encoding, facial recognition, logo recognition, and visual inspection by humans may also be used in various embodiments. Systems and methods for matching uploaded content against reference content are described for example in U.S. patent application Ser. Nos. 11/765,292; 11/746,339; 60/957,446; and 60/957,445, each of which is incorporated by reference herein. In one embodiment, UGC is analyzed in its uploaded format prior to being transcoded.

If 212 the specified policy indicates that the content should be taken down, i.e. removed from the site, system 100 removes 214 the UGC from the site. If the policy does not specify a take down policy, then the user's context is identified 216. The user's context may include, for example, his region, his domain, the type of device he is using, and the like. Different policies may accordingly be specified by content owners 108 to be applied to each different user context. For example, for the particular item of UGC, a policy may specify revenue sharing in the United States, but block viewing of the content in the United Kingdom. Once the user's context has been identified, policy engine 118 applies 218 the appropriate policy.

Finally, if identification module 116 matches the UGC to an item of reference content, but with a confidence level less then a specified threshold, the UGC and suggested matching reference content is queued 220 for manual review by content owner 108. If 226 content owner 108 claims the content as its own, the content is treated 210 in accordance with the appropriate policy as described above. If, on the other hand, the content owner 108 does not claim the content as its own, the content is published 228 for viewing by viewers 124 without implementing any of the described policies. In either event, in one embodiment the UGC or its indicia is added to reference database 112 to improve accuracy of future identification attempts.

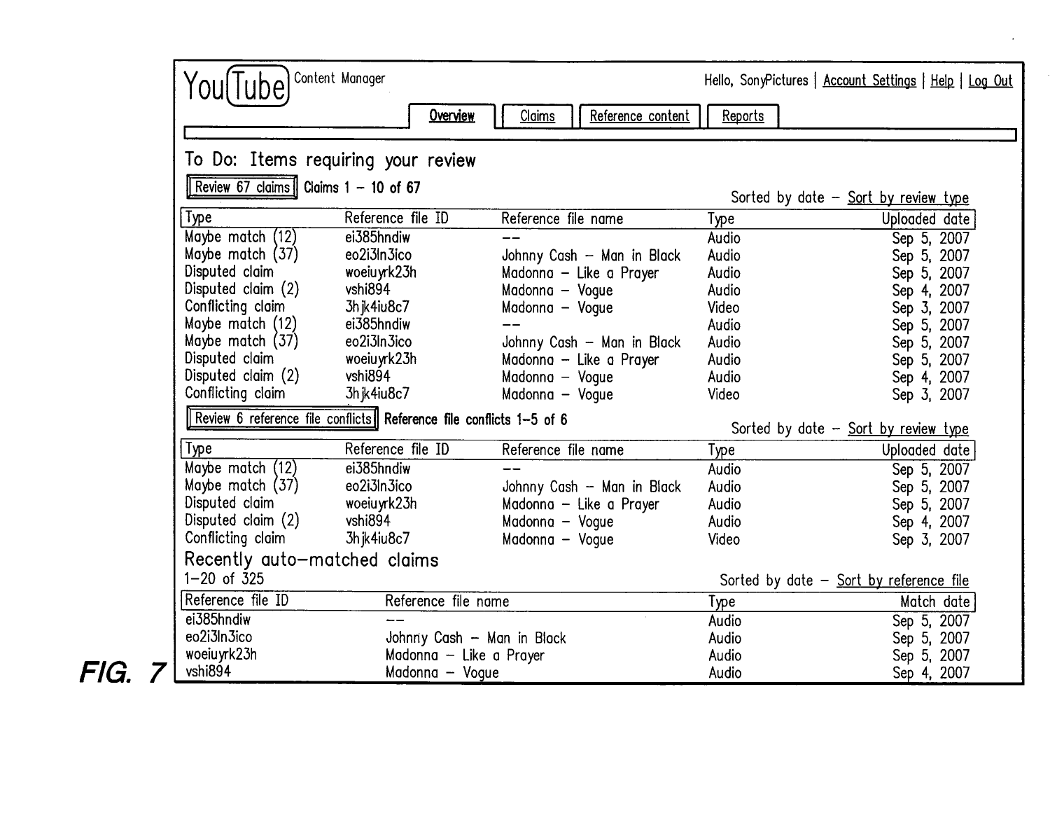

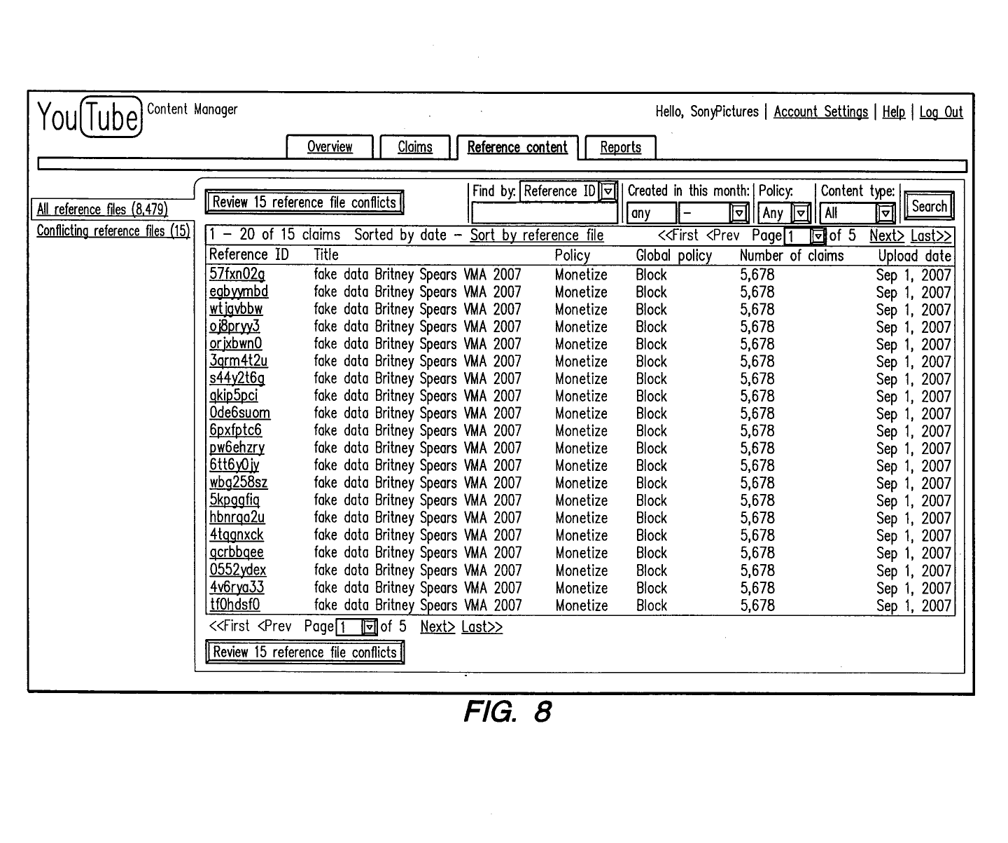

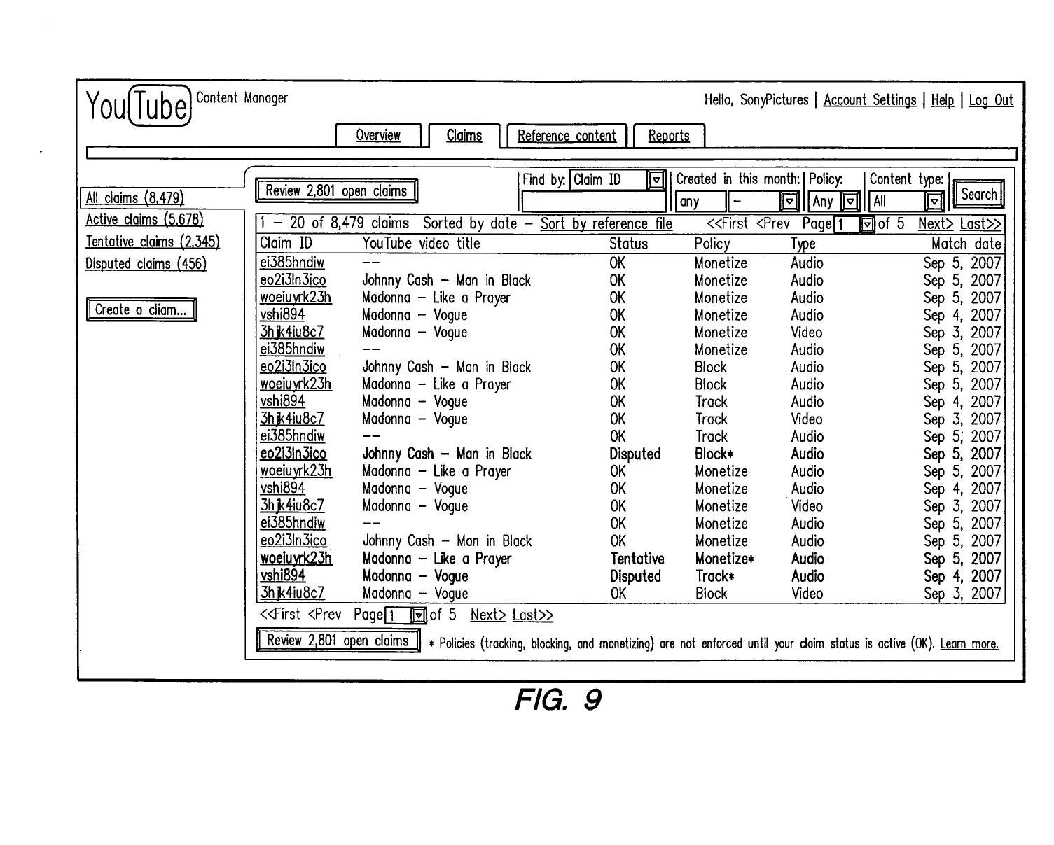

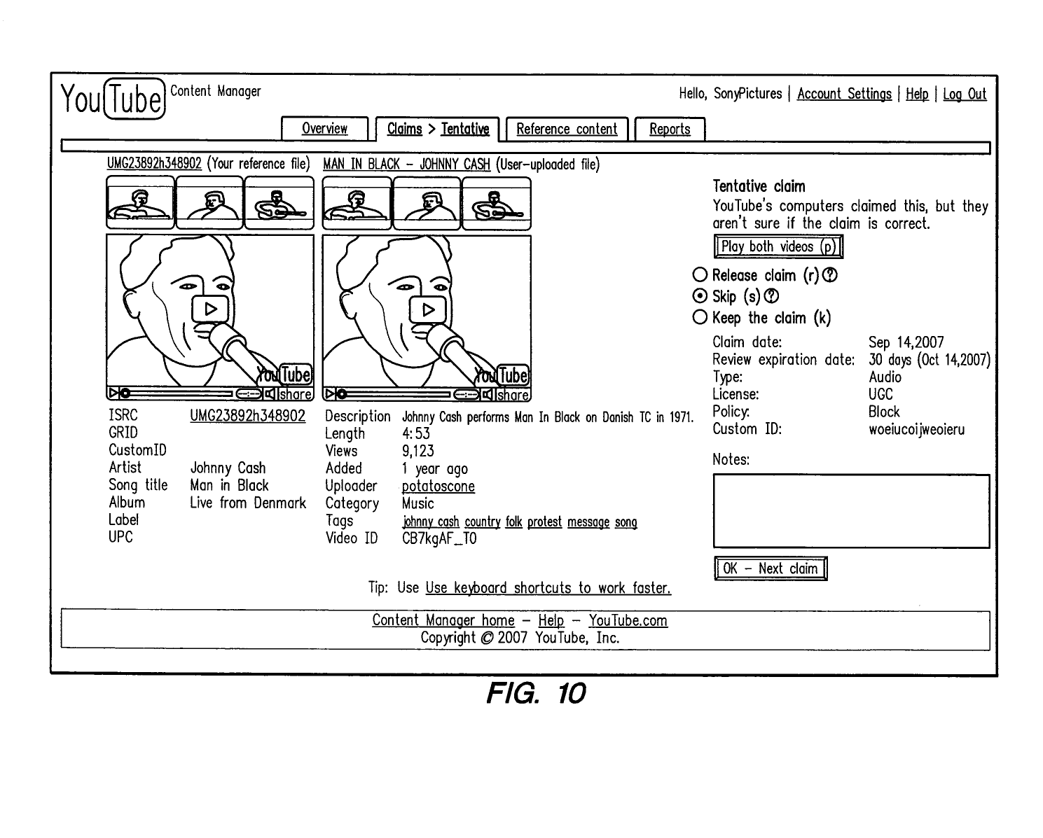

FIG. 7 illustrates an example of a user interface 700 that is used by content owner 108 to review and claim content. In this example, reference content and user-uploaded content are displayed side by side. A content owner 108 can review the potential match and release, skip, or keep the claim. He can then view a next potential claim for similar processing. In the figure, a claim expires after a predetermined number of days, such as 30. In other embodiments, claims do not expire. Here, the content owner has a general policy of “block” for matched content. In one embodiment, only the user-uploaded content is displayed, not the reference content.

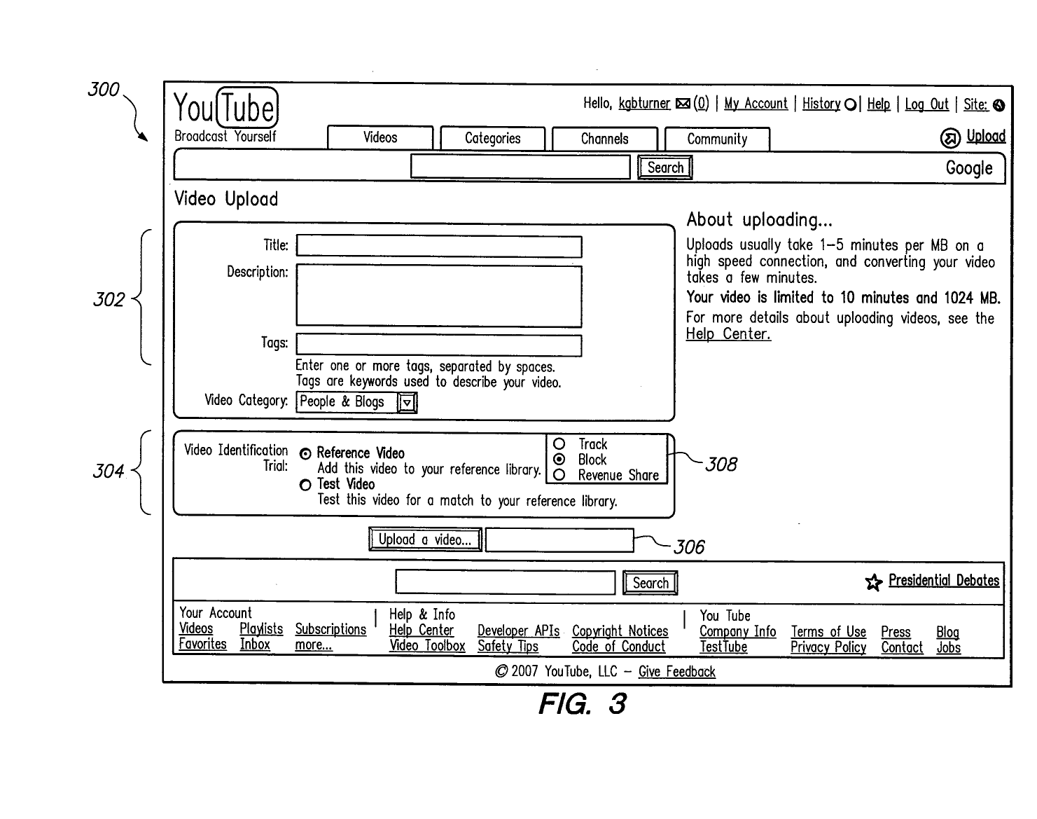

FIG. 3 illustrates an example of a user interface page 300 of content owner interface 126 that enables a content owner 108 to upload a reference video to reference database 112. In the illustrated example, one region 302 provides inputs for the content owner 108 to specify the title, description and tags associated with the reference work. In region 304, content owner 108 can specify whether the uploaded video is a reference video, or is a test video intended to be tested against videos already in reference database 112. If content user 108 specifies that the uploaded video is a reference video, it may further specify a policy 308, such as track, block or revenue share. Finally, a location, e.g., on the content owner's local computer, is specified in box 306, and the reference video is then uploaded to system 100. In one embodiment, content owners can upload reference videos in batch mode instead of uploading each individually. In one embodiment, content owners can upload video fingerprints in batch mode instead of uploading each fingerprint individually.

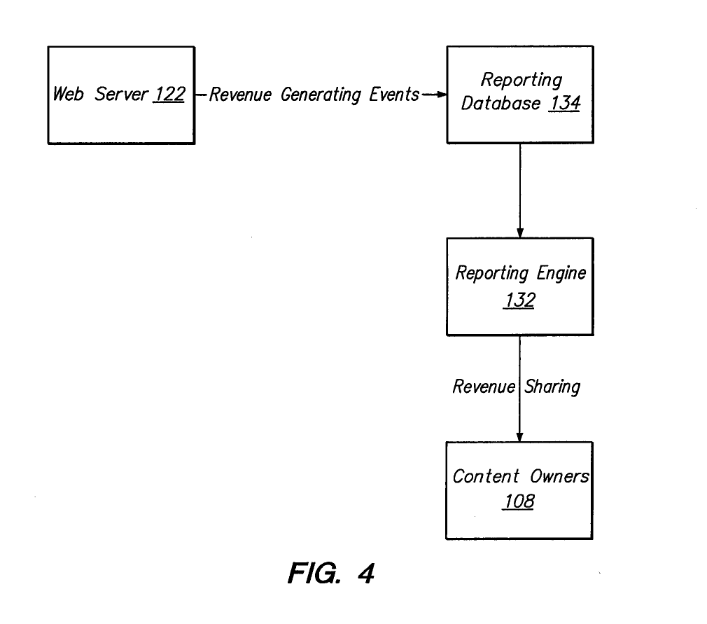

FIG. 4 illustrates a way of providing revenue sharing in accordance with an embodiment of the present invention. Each time a revenue-generating event occurs, for example an advertising impression, click-through, a sale, etc., on a page containing UGC for which revenue sharing applies (or for a revenue generating event associated with the specific video), a record of the event is added to reporting database 134. Reporting engine 132 analyzes the events in reporting database 134 to determine for each event what amount, if any, of revenue should be allocated to which content owners. Reporting engine 132 then provides a report to relevant parties such as the operator of system 100, the content owners 108, etc. and revenue is distributed accordingly.

In one embodiment, web server 122 also generates data including but not limited to view counts, play length, etc. This information can also be used by reporting engine 132 to allocate shared revenue if the agreement between the parties so specifies.

For example, if a user 102 has uploaded content belonging to a content owner 108, and the content owner has a policy for that content of revenue sharing, the content owner 108 and the user 102 may share the revenue from the sales activity. This sharing can be done in any appropriate way such as sharing by percentage, by a flat payment, by payment per view, and so on, as specified by the content owner or as negotiated by the parties. Where multiple content owners exist, they may share together in the negotiated revenue. This is particularly so, for example, in the case of music due to the highly fragmented rights holder landscape.

As another example, if a user 102 has uploaded content belonging to a content owner 108, and the content owner has a policy for that content of revenue sharing, the content owner 108 and the entity controlling the website on which the content is viewable may share the revenue from the sales activity. This sharing can be done in any appropriate way such as sharing by percentage, by a flat payment, by payment per view, and so on, as specified by the content owner or as negotiated by the parties. Where multiple content owners exist, they may share together in the negotiated revenue. This is particularly so, for example, in the case of music due to the highly fragmented rights holder landscape. In such a situation, this arrangement would override any possibility that the user who uploaded the video would share in revenue derived from the video.

As another example, the content owner may have a policy indicating that he wants “promotion” of his content instead of receiving some or all of a revenue stream. Promotion can include, for example, desirable placement on the web site or additional ads or content being displayed alongside the content. For example, a promoted video may receive a special ad for other properties of the content holder that is displayed next to the content, in lieu of the content owner directly receiving revenue.

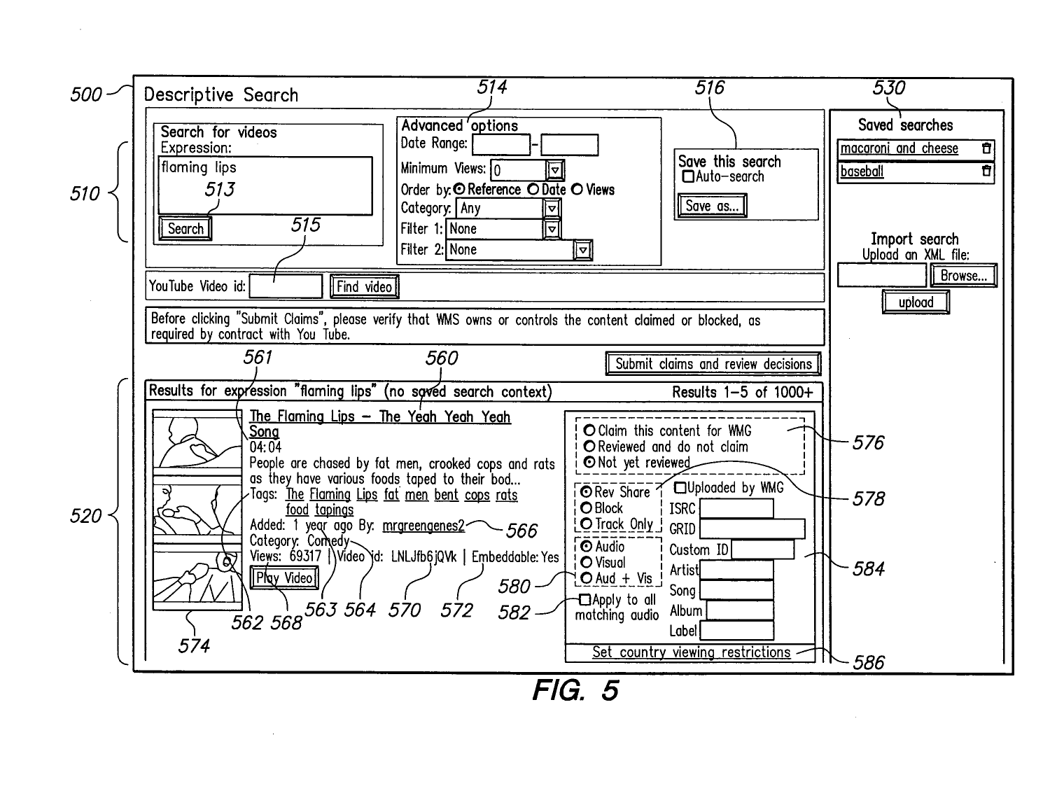

FIG. 5 is a screen shot of a search function user interface 500 in accordance with an embodiment of the present invention. A content owner 108 or its representative can use user interface 500 to identify examples of its content on the host site. Note that there may be more than one instance of particular content on the site. For example, a music video may have outtakes posted, in addition to pure audio, pure video, mashups including the music video, etc.

In the example, the user interface includes a search area 510 and a search result area 520. Search area 510 includes an area for entry of search terms (such as “flaming lips”, in the illustrated case). One embodiment allows the user to search within certain fields or metadata fields such as author and title. Once the content owner enters search terms, he initiates the search by selecting button 513.

The user can also set advanced search options 514, including but not limited to date range and minimum number of views. The user can also order the results by relevance, date, or numbers of views (in either ascending or descending order), and further narrow the search to a specific category. The user in one embodiment filter by claim status to either remove all previously marked content from the results, or conversely to look specifically at content that has been previously marked. Another filter allows the content owner 108 to filter out content previously reviewed and not marked as that of the user. Content owner 108 can also search for a specific video by entering its ID into text box 515.

In this example, area 516 includes two options for saving the search: either auto search, which means that the search will be performed in the future at user-specified times or situations (or at predetermined times and situations in other embodiments); and/or as an incremental search, i.e. as a record of the results of a particular search and its terms. In one embodiment, auto search sends the content owner a daily email with counts on how their defined searches are performing. Incremental search filters those daily emails to only show results from the last 24 hours.

Area 530 allows the user to select a saved search. The XML option allows content owners to define all the parameters of a search, as seen in the UI, in an XML file on their servers, which they can then upload to their list of saved searches. The browse function allows them to find XML files on their local machine for this purpose. This allows a content owner to leverage its content database to build a list of searches.

Area 520 shows an example of search results for a content search. In the example, the resulting content has a name 560, a duration 561, tags 562, an add date 563, a category 564, a source 566, a number of views 568, a video ID 570, and an indication 572 of whether the video is embeddable. Also shown are three thumbnail images 574 illustrating different portions of the identified video. Other embodiments may include other types of data or metadata about the content.

For each piece of content, the content owner 108 may indicate in region 576 that it wishes to claim the content for itself; that it has reviewed the content and does not claim it; or that it has not yet reviewed the content. If the content owner 108 claims the content, then it also selects in region 578 a policy option—here, either revenue share, block, or track only. In region 580, the content owner 108 indicates whether its claim applies to the audio, the visual, or both components of the content item. A checkbox 582 further allows content owner 108 to specify that a claim for audio should apply to any instance of that audio found in UGC, regardless of the visual content it may be paired with.

Where the content owner 108 is itself the source of the located content, it can so indicate in region 584, additionally providing metadata about the content item.

Finally, the content owner 108 can select link 586 to specify a different set of parameters for different regions or countries.

Content, or indicia of content, that has been newly claimed by content owner 108 is in one embodiment then stored in reference database 112 to allow for automated identification of the content the next time it is seen by identification module 116.

Some content owners 108 are reluctant to distribute reference copies of their content to domains outside of their control. In one embodiment, this concern is addressed by allowing content owners 108 to provide indicia of reference content, rather than the reference content itself, to system 100. Typically, the indicia of reference content is a digital fingerprint that is derived from the reference content, but which cannot be effectively translated back into the original reference content. In this embodiment, identification module 116 uses a fingerprinting algorithm to obtain a fingerprint from uploaded UGC, and to compare it to fingerprints stored in reference database 112. Content owner 108 can further provide policy information to system 100 as described above, except that the policy information is mapped to the fingerprint ID, rather than to the original reference content.

In one embodiment, content owner 108 maintains its own policy database 114. This enables content owners 108 to update policy data without having to use content owner interface 126, or to connect to system 100 at all. Policy changes are made locally by content owner 108, and when a match is detected by system 100, policy engine 118 retrieves the appropriate policy from content owner 108 in real time, rather than from a policy database local to system 100.

In one embodiment, content owner 108 supplies reference fingerprints of content data to system 100, along with associated URLs. When a UGC fingerprint matches a reference fingerprint, the UGC and the URL are forwarded to the content owner 108 for review. The supplied URL is a URL available to the content owner 108, but not to system 100, and references the reference content identified by the fingerprint. The content owner 108 can thus make the comparison to determine whether the UGC contains the reference content without having to make the reference content available to system 100. In an alternative embodiment, the manual identification process is undertaken only when an automatic identification lacks a threshold level of confidence.

In one embodiment, identifying uploaded UGC to determine whether it matches reference content can take some time, which depends on the rate and volume of content being uploaded, as well as the processing power available. Consequently, UGC may be sent to publisher 120 for publication on web server 122 in parallel with identification engine 116. Once identification engine 116 completes the matching process, the published content is either allowed to remain in place, if no match was found, or the appropriate policy is applied to the content if a match was found. In other embodiments, the content is not posted to the site until its status has been determined.

An additional dimension is added when rights are considered from an international perspective. For a particular work, the rights holder in one country may be an entirely different entity than the rights holder in another country. This can lead to the conflict, for example if the rights holder in the United States sets a policy of revenue share, while the rights holder in Canada set the policy of takedown. In that instance, the system publishes the UGC and enables revenue share when the content is served to account holders in United States, while the content is blocked when the user with a Canadian account attempts to view it.

In one embodiment, the operator of system 100 can apply its own policy to identified UGC either in addition to or in place of a policy set by content owner 108. For example, the operator of system 100 may determine that a particular video should be blocked in Thailand, and may apply that policy to a particular UGC, or to a set of UGC, or to all content.

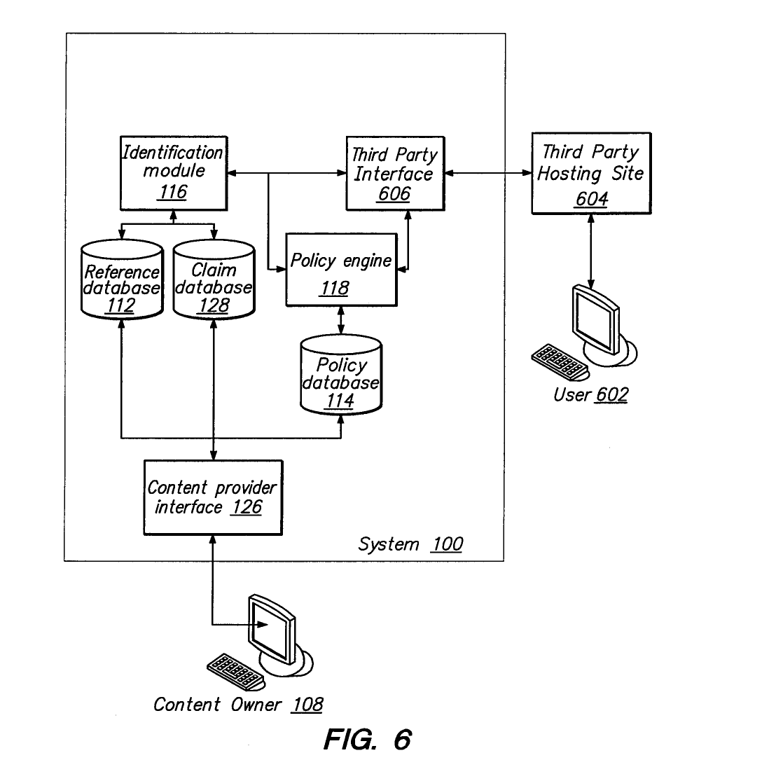

In one embodiment, system 100 identifies UGC and matches content with appropriate policies as a service to third parties. For example, referring to FIG. 6, a host site 604 receives UGC from one of its users 602. Host site 604 wishes to provide the UGC to others of its users, but only if doing so is permitted by the true owner of the content. Third party hosting site 604 may not have the resources to identify content owners, or may for its own reasons wish to obtain identification from another source. The third party hosting site 604 therefore provides the UGC or indicia such as a fingerprint of the UGC to third party interface 606 of system 100. Identification module compares the UGC or fingerprint against reference content stored in reference database 112. If there is no match, third party interface 606 reports to third party hosting site 604 that the UGC does not match any content known to system 100. Alternatively, if a match is found in reference database 112, then the UGC is either subject to a policy provided by content owner 108 and stored in policy database 114, or it is UGC that has been previously seen but not subjected to a claim. In the former case, policy engine looks up the appropriate policy for the identified content, and third party interface 606 returns the policy information to third party hosting site 604, and may also return additional meta-information such as the canonical name of the content, copyright information, and the like. In the latter case, third party interface 606 informs third party hosting site 604 that the content has been previously seen by system 100, but that no claim has been made against the content by any content owner 108.

In one embodiment, system 100 charges a fee to perform content identification on behalf of third party hosting sites 604.

In one embodiment, system 100 performs the function of content identification on behalf of third party hosting sites 604, but does not provide accompanying policy information. In an alternative embodiment, system 100 provides policy information for a given content identifier, but does not perform the content identification.

Accordingly, embodiments of the present invention help secure for content owners more control over their works. It also gives content owners new options for not only regulating who can make use of their content, but an ability to derive revenue from their content in additional ways, such as revenue sharing with UGC contributors. Content owners additionally have access to a broad range of content management tools, and are not compelled to disclose original reference content in order to take advantage of content rights management.

The present invention has been described in particular detail with respect to a limited number of embodiments. Those of skill in the art will appreciate that the invention may additionally be practiced in other embodiments.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component. For example, the particular functions of match module 116, policy module 118, and so forth may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “selecting” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for providing content usage information, the method comprising:
receiving indicia of user-generated content from a sender;
identifying an item of reference content associated with the received indicia;
determining for the item of reference content a usage policy for the content; and
providing to the sender the usage policy.

2. The method of claim 1 wherein the sender is a video hosting site and the user-generated content is received by the video hosting site from a user of the video hosting site.

3. The method of claim 2 further comprising receiving a fee from the video hosting site in response to providing the usage policy.

4. The method of claim 1 wherein the received indicia includes a fingerprint of the user-generated content.

5. The method of claim 1 further comprising providing to the sender meta-information about the item of reference content.

6. The method of claim 5 wherein the meta-information includes a canonical name of the reference content.

7. The method of claim 5 wherein the meta-information includes copyright information associated with the reference content.

8. The method of claim 1 wherein the received indicia includes metadata.

9. The method of claim 8 wherein the associated metadata includes a title of the user-generated content.

10. The method of claim 8 wherein the associated metadata includes at least one keyword.

11. The method of claim 1 wherein the user-generated content includes audio and video content.

12. The method of claim 1 wherein the reference content is provided by an owner of the reference content.

13. The method of claim 1 wherein the usage policy specifies that the user-generated content may be viewed.

14. The method of claim 13 wherein the usage policy further specifies that viewing of the user-generated content is to be tracked.

15. The method of claim 1 wherein the usage policy specifies that the user-generated content may not be viewed.

16. The method of claim 1 wherein the usage policy specifies that the user-generated content is to be removed.

17. The method of claim 1 wherein the usage policy specifies that the user-generated content is to be viewed in exchange for compensation.

18. A content management system for providing management of digital content of third party sites, comprising:
a third party input server adapted to receive an identification of an item of user-generated content from a third party site;
an identification module, coupled to the third party input server, adapted to identify an item of reference content associated with the item of user-generated content;
a policy engine, coupled to the identification module, adapted to determine a usage policy associated with the item of reference content; and
a publisher, coupled to the policy engine, adapted to transmit the usage policy to the third party web site.

19. The content management system of claim 18, wherein the publisher also transmits an identification of the item of user-generated content to the third party web site.

20. The content management system of claim 18, wherein the third party site is a video hosting web site.
